(19) United States
(12) Patent Application Publication
(10) Pub. No.: US 2018/0290387 A1
(43) Pub. Date: Oct. 11, 2018

(54) THREE-DIMENSIONAL PROCESSING DEVICE

(71) Applicant: Roland DG Corporation, Hamamatsu-shi, Shizuoka (JP)

(72) Inventors: Makoto YOSHIDA, Hamamatsu-shi (JP); Kazutoshi FUNAKOSHI, Hamamatsu-shi (JP); Akihiro SUZUKI, Hamamatsu-shi (JP)

(21) Appl. No.: 16/064,534

(22) PCT Filed: Nov. 28, 2016
(86) PCT No.: PCT/JP2016/085201

§ 371 Date: Jun. 21, 2018

(30) Foreign Application Priority Data
Dec. 22, 2015 (JP) 2015-249524

(51) Int. Cl. B29C 64/393; B29C 64/209; B29C 64/124; B29C 64/295

(52) U.S. Cl. CPC B29C 64/393; B29C 64/209; B33Y 50/02; B29C 64/295; B29C 64/124

(57) ABSTRACT

A three-dimensional processing device includes a printing head that discharges a resin material based on three-dimensional data of a three-dimensional object, a scan head that measures a surface shape of the three-dimensional object printed with the resin material, a processing head that processes a surface of the printed three-dimensional object, and a controller that includes a printing head controller that controls the printing head, a scan head controller that controls the scan head, a specifier that specifies an extra portion, which is a difference between the measured surface shape of the three-dimensional object and a surface shape of a three-dimensional object theoretically printed based on the three-dimensional data, and a processing head controller that controls the processing head such that the processing head cuts the extra portion.

### BACKGROUND OF THE INVENTION

### 1. Field of the Invention

The present invention relates to a three-dimensional processing device.

### 2. Description of the Related Art

Conventionally, a three-dimensional printing device that prints a three-dimensional object by curing a resin material and sequentially stacking cured resin layers each having a predetermined cross-sectional shape is known. One known three-dimensional printing device of this type prints a three-dimensional object by, for example, fused deposition modeling as described in Japanese Patent Application Publication No. Hei 07-227895. According to the fused deposition modeling, a thermoplastic resin is softened and then cured to form a cured resin layer. Such a three-dimensional printing device includes a printing head discharging a resin material based on three-dimensional data of a three-dimensional object to be printed.

A surface of a three-dimensional object printed by such a three-dimensional printing device is conventionally processed as follows. The printed three-dimensional object is moved to a cutting device, which is separate from the three-dimensional printing device, and then is processed. For processing such a printed three-dimensional object, the shape of the three-dimensional object needs to be found accurately. Therefore, a surface shape of the printed three-dimensional object is measured by a measuring device, which is separate from the three-dimensional printing device and also the cutting processing device.

However, the three-dimensional printing device, the measuring device and the cutting processing device are not compatible with each other regarding information on the shape or the position of the three-dimensional object. Therefore, it is difficult to perform a cutting process on the printed three-dimensional object. This will be described more specifically. The three-dimensional object is moved from the three-dimensional printing device to the measuring device, and therefore, the surface shape of the printed three-dimensional object is measured. However, the difference in the shape between the printed three-dimensional object and a three-dimensional object theoretically printed based on three-dimensional data is not clear. Therefore, it is not possible to accurately determine which portion of the three-dimensional object is to be cut or how much the portion is to be cut. Since the difference in the shape between the printed three-dimensional object and the three-dimensional object theoretically printed based on the three-dimensional data is not clear, the cutting processing device needs to cut the printed three-dimensional object sequentially from an outermost portion thereof, which involves a problem of extending the time required for the cutting process.

### SUMMARY OF THE INVENTION

Preferred embodiments of the present invention provide three-dimensional processing devices that decrease the time required to print, measure and process a three-dimensional object and provide a high quality three-dimensional object.

A three-dimensional processing device according to a preferred embodiment of the present invention includes a printing head that discharges a resin material based on three-dimensional data of a three-dimensional object to be printed; a printing table that holds the resin material discharged from the printing head; a scan head that measures a surface shape of the three-dimensional object located on the printing table and printed with the resin material; a processing head that processes a surface, having the measured shape, of the three-dimensional object located on the printing table; and a controller that controls the printing head, the scan head and the processing head. The controller is configured or programmed to include a printing head controller that controls the printing head such that the printing head discharges the resin material toward the printing table based on the three-dimensional data; a scan head controller that controls the scan head such that the scan head measures the surface shape of the three-dimensional object located on the printing table based on the three-dimensional data; a specifier that specifies an extra portion, which is a difference between the surface shape of the three-dimensional object measured by the scan head and a surface shape of a three-dimensional object theoretically printed based on the three-dimensional data; and a processing head controller that controls the processing head such that the processing head cuts the extra portion.

With a three-dimensional processing device according to a preferred embodiment of the present invention, at the time of measuring and processing the three-dimensional object, printed on the printing table, by the scan head and the processing head, the position of the origin does not need to be adjusted, for the following reasons. The relative positions of the scan head and the processing head are specified by the three-dimensional processing device, and the scan head and the processing head use the same three-dimensional data of the three-dimensional object. The scan head controller controls the scan head such that the scan head measures the surface shape of the three-dimensional object based on the three-dimensional data. Now, based on the three-dimensional data, the portion of the printing table at which the three-dimensional object is located is determined. Therefore, the surface shape of the three-dimensional object is able to be measured after the scan head is moved to the vicinity of the three-dimensional object. Specifically in the case where the scan head includes the contact sensor that contacts a target to measure the shape thereof, the total time in which the scan head moves is significantly reduced. The processing head controller controls the processing head such that the processing head cuts the extra portion specified by the specifier. The specifier clarifies which portion of the printed three-dimensional object needs to be cut and how much the portion needs to be cut. Therefore, the processing head may be moved immediately to the extra portion for processing. This significantly shortens the total time for the processing head to be moved. In general, the time required to discharge the thermoplastic resin to print the three-dimensional object is longer than the time required to process the surface of the three-dimensional object by the processing head. The time required for the printing may be shortened by, for example, increasing the diameter of the thermoplastic resin discharged from the printing head and thus increasing the amount of the thermoplastic resin discharged per unit time. However, in this case, the precision of the shape of the three-dimensional object is decreased. By contrast, according to a preferred embodiment of the present invention, even if the amount of the thermoplastic resin discharged per unit time from the printing head is increased and thus the three-dimensional object has a rough surface shape, the printed three-dimensional object finally provided is of a high quality because the surface of the three-dimensional object is processed after the printing. Namely, the time required to print the three-dimensional object is shortened.

Preferred embodiments of the present invention provide three-dimensional processing devices that decrease the time required to print, measure and process a three-dimensional object and provide a high quality three-dimensional object.

The above and other elements, features, steps, characteristics and advantages of the present invention will become more apparent from the following detailed description of the preferred embodiments with reference to the attached drawings.

### BRIEF DESCRIPTION OF THE DRAWINGS

FIG. 1 is a perspective view of a three-dimensional processing device according to a preferred embodiment of the present invention.

FIG. 2 is a block diagram of a controller in a preferred embodiment of the present invention.

FIG. 3 shows a state where a thermoplastic resin is discharged from a nozzle of a printing head toward a printing table in a preferred embodiment of the present invention.

FIG. 4 shows a target three-dimensional object theoretically printed based on three-dimensional data.

FIG. 5 shows a three-dimensional object actually printed based on the three-dimensional data.

FIG. 6 shows a state before a scan head measures a surface shape of the three-dimensional object.

FIG. 7 shows a state where the scan head is measuring the surface shape of the three-dimensional object.

FIG. 8 is a state before a processing head processes a surface of the three-dimensional object.

FIG. 9 is a state where the processing head is processing the surface of the three-dimensional object.

FIG. 10 shows the three-dimensional object having the surface thereof processed by the processing head.

### DETAILED DESCRIPTION OF THE PREFERRED EMBODIMENTS

Hereinafter, three-dimensional processing devices in preferred embodiments of the present invention will be described with reference to the drawings. The preferred embodiments described below are not intended to specifically limit the present invention in any way. Components and portions that have the same functions will bear the same reference signs, and overlapping descriptions will be omitted or simplified optionally.

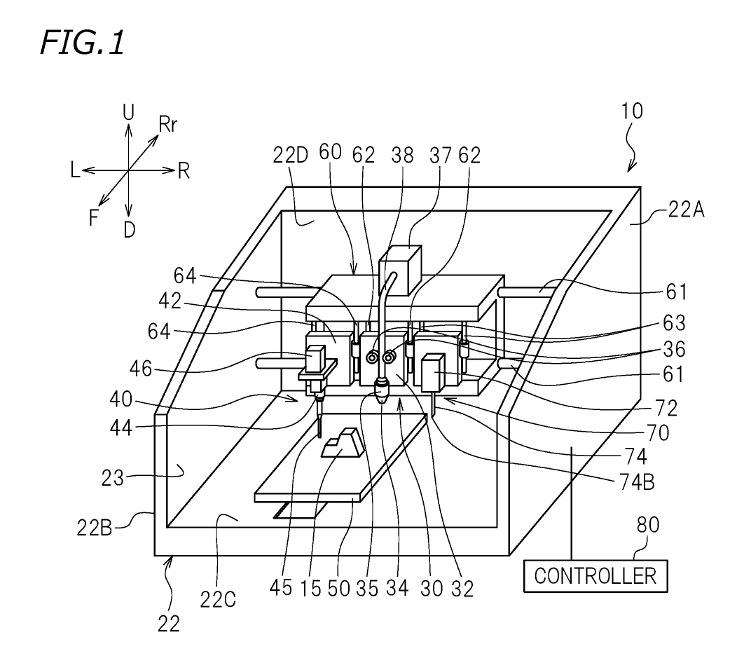

FIG. 1 is a perspective view of a three-dimensional processing device 10 according to a preferred embodiment of the present invention. The three-dimensional processing device 10 is a device that prints a three-dimensional object. The three-dimensional processing device 10 is a device that prepares slice images representing cross-sectional shapes of a three-dimensional object, cures a resin material, and sequentially stacks cured resin layers having cross-sectional shapes in accordance with the slice images to print the three-dimensional object. The three-dimensional processing device 10 is a device that measures a surface shape of the printed three-dimensional object. The three-dimensional processing device 10 is a device that processes a surface of the printed three-dimensional object. Herein, the term “cross-sectional shapes” refers to shapes of cross-sections provided by slicing the three-dimensional object at intervals of a predetermined thickness (e.g., at intervals of about 0.1 mm). In this preferred embodiment, an example in which a thermoplastic resin is used as the resin material will be described.

In the following description, the terms “left”, “right”, “up” and “down” represent left, right, up and down as seen from an operator who faces a front surface of the three-dimensional processing device 10. A direction approaching the operator from the three-dimensional processing device 10 is expressed as “forward”, and a direction distanced away from the operator toward three-dimensional processing device 10 is expressed as “rearward”. In the drawings, letters F, Rr, L, R, U and D respectively represent front, rear, left, right, up and down. These directions are merely provided for the sake of convenience, and do not limit the form of installment of the three-dimensional processing device 10 in any way.

As shown in FIG. 1, the three-dimensional processing device 10 includes a housing 22, a printing head 30, a processing head 40, a printing table 50, a controller 80, a carriage 60, and a scan head 70.

As shown in FIG. 1, the housing 22 includes a right wall 22A, a left wall 22B, a bottom wall 22C and a rear wall 22D. The housing 22 is provided with an opening 23 extending from a top portion to a front portion thereof. The housing 22 includes a cover (not shown) that covers the opening 23.

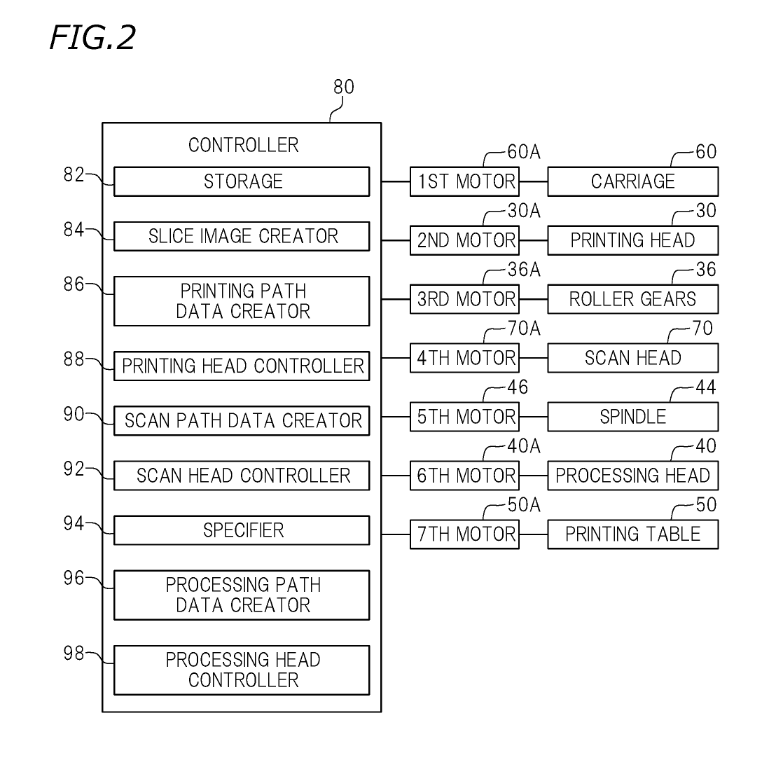

As shown in FIG. 1, the carriage 60 is located in the housing 22. The carriage 60 is movable along a pair of first guide rails 61 located in the housing 22. The carriage 60 is movable in a left-right direction along the first guide rails 61. The first guide rails 61 extending in the left-right direction is connected with the right wall 22A and the left wall 22B. The carriage 60 is moved in the left-right direction upon receipt of a driving force of a first motor 60A (see FIG. 2). The first motor 60A is controlled by the controller 80. The carriage 60 includes a pair of second guide rails 62, a pair of third guide rails 63 and a pair of fourth guide rails 64. The second guide rails 62, the third guide rails 63 and the fourth guide rails 64 extend in an up-down direction. The second guide rails 62 are located to the left of the third guide rails 63. The second guide rails 62 are located to the right of the fourth guide rails 63.

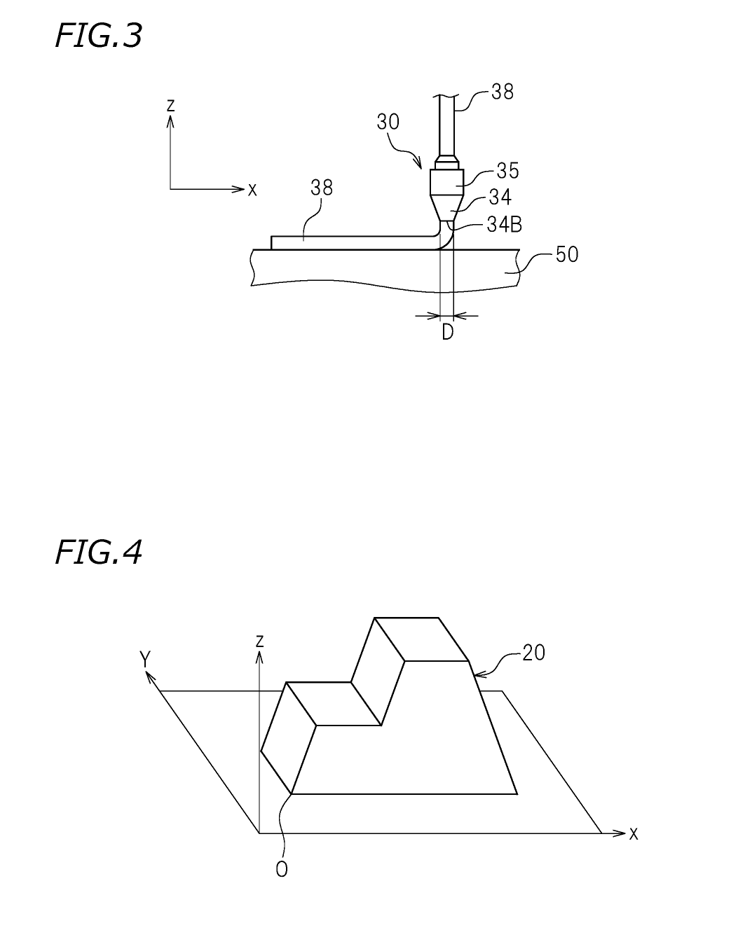

The printing head 30 discharges a thermoplastic resin 38 based on three-dimensional data of a three-dimensional object 15 to be printed. As shown in FIG. 1, the printing head 30 is located in the housing 22. The printing head 30 is located on the carriage 60. The movement of the carriage 60 in the left-right direction causes the printing head 30 to move in the left-right direction. The printing head 30 is movable along the second guide rails 62. The printing head 30 includes a main body 32, a nozzle 34 discharging the thermoplastic resin 38, a heater 35, and a pair of roller gears 36. The main body 32 is movable along the second guide rails 62. The main body 32 is moved in the up-down direction upon receipt of a driving force of a second motor 30A (see FIG. 2). This moves the printing head 30 in the up-down direction. The second motor 30A is controlled by the controller 80. Above the carriage 60, a cartridge 37 is located. The cartridge 37 accommodates the thermoplastic resin 38. The cartridge 37 is exchangeable. As shown in FIG. 3, the nozzle 34 discharges the thermoplastic resin 38 transported from the cartridge 37 (see FIG. 1) toward the printing table 50. The nozzle 34 may have a changeable nozzle diameter D. An opening of the nozzle 34 is circular or substantially circular, for example. In the case where the opening of the nozzle 34 is rectangular or substantially rectangular, the length of a longer diameter of the opening is the nozzle diameter D. The nozzle diameter D may be increased to raise the speed of printing of the three-dimensional object 15. The nozzle diameter D may be decreased to raise the precision of printing of the three-dimensional object 15. The heater 35 heats the thermoplastic resin 38 transported from the cartridge 37. The heater 35 is attached to the main body 32. The heater 35 is located above the nozzle 34. As shown in FIG. 1, the roller gears 36 are provided on the main body 32. The pair of roller gears 36 separate and spaced from each other. The roller gears 36 are rotated upon receipt of a driving force of a third motor 36A (see FIG. 2). The third motor 36A is controlled by the controller 80. The thermoplastic resin 38 transported from the cartridge 37 passes between the pair of roller gears 36. The rotation of the roller gears 36 causes the thermoplastic resin 38 to be transported to the nozzle 34 and to be discharged from the nozzle 34 toward the printing table 50. The thermoplastic resin 38 is softened by the heat of the heater 35 and is discharged toward the printing table 50 in such a soft state. The thermoplastic resin 38 discharged onto the printing table 50 is then cured. The printing head 30 sequentially stacks cured resin layers having predetermined cross- sectional shapes corresponding to slice images created by the controller 80. As a result, the three-dimensional object 15 is printed as being desired.

The scan head 70 measures a surface shape of the three-dimensional object 15 printed with the cured thermoplastic resin 38. As shown in FIG. 1, the scan head 70 is located in the housing 22. The scan head 70 is provided on the carriage 60. The movement of the carriage 60 in the left-right direction causes the scan head 70 to move in the left-right direction. The scan head 70 is movable along the third guide rails 63. The scan head 70 is located to the right of the printing head 30. The scan head 70 moves integrally with the printing head 30 and the processing head 40. The scan head 70 includes a main body 72 and a contact sensor 74. The main body 72 is movable along the third guide rails 63. The main body 72 moves in the up-down direction upon receipt of a driving force of a fourth motor 70A (see FIG. 2). This moves the scan head 70 in the up-down direction. The fourth motor 70A is controlled by the controller 80. The contact sensor 74 is attached to the main body 72 so as to be movable in the up-down direction. A bottom end 74B of the contact sensor 74 is located below the main body 72. The movement of the contact sensor 74 is controlled by the controller 80. To measure the surface shape of the three-dimensional object 15 located on the printing table 50, the contact sensor 74 moves downward from the main body 72 to contact the three-dimensional object 15. This operation is repeated, so that the surface shape of the three-dimensional object 15 is measured. The scan pitch of the scan head 70 may be increased to measure surface shapes at predetermined points of the three-dimensional object 15 (sample scan). The scan pitch may be, for example, D or greater and 3D or less, where the nozzle diameter is D. In this case, the sample scan actually measures how much of the three-dimensional object 15 printed by stacking the cured resin layers is to be cut, more specifically, the thickness of a surface portion of the three-dimensional object 15 to be cut (average value of thicknesses of the surface portion to be cut, the surface portion to be cut including convex and concave portions) and also actually measures the thickness variance and the maximum value of the thicknesses. The above-described measurement is performed partly on portions of the three-dimensional object 15. From the results of the sample scan, how much of the three-dimensional object 15 is to be cut, namely, the approximate thickness of the cured resin layers to be cut away, is estimated regarding the entirety of the three-dimensional object 15. Also estimated from the results of the sample scan is the maximum value of the thicknesses of the entirety of the three-dimensional object 15. Since the maximum value of the thicknesses of the three-dimensional object 15 is estimated, the distance between the surface of the three-dimensional object 15 immediately after the printing is finished and the initial position of the tip of a blade is able to be reduced or minimized. Namely, the initial position of the tip of the blade against the surface of the three-dimensional object 15 can be set at the closest when the cutting process is started. Thus, the time for the cutting process is shortened. Namely, the time in which the processing head 40 moves around in a space where no process is needed (height greater than, or equal to, the maximum value of the thicknesses of the three-dimensional object 15) is saved.

It is known that in the case where the printing is performed by stacking the layers of the thermoplastic resin 38 discharged from the nozzle 34 as described above, the variance in the thickness of a surface portion of the cured resin layer to be cut from the three-dimensional object 15 immediately after the printing is finished is approximately the same entirely. Especially, the variance in the thickness of such a surface portion in a flat portion of the three-dimensional object 15 is approximately the same entirely. Therefore, the entire surface shape of the three-dimensional object 15 may be estimated based on the sample scan described above. In the case where the three-dimensional object 15 includes a protrusion (partially convex portion) or a hole (partially concave portion) in a portion thereof, it may be advisable to scan the protrusion or the hole and the vicinity thereof (spot scan) in addition to performing the sample scan. In the case where the flat portion is small, in the case where the three-dimensional object is spherical with no flat portion (e.g., is dome-shaped), or in the case where the three-dimensional object includes only of convex and concave curved surfaces, the thickness of the convex and concave portion may be varied and thus unexpectable if the thermoplastic resin 38 has a certain viscosity or a certain temperature or if the stacking is performed by a certain method, for example, if the stacking is performed at a certain speed or in a certain direction. In such a case, the scan pitch of the scan head 70 may be made smaller than D, so that the scan head 70 measures the entire surface shape of the three-dimensional object 15 (full scan).

The processing head 40 processes the surface, of the three-dimensional object 15, the shape of which has been measured. As shown in FIG. 1, the processing head 40 is located in the housing 22. The processing head 40 is provided on the carriage 60. The movement of the carriage 60 in the left-right direction causes the processing head 40 to move in the left-right direction. The processing head 40 is movable along the fourth guide rails 64. The processing head 40 is located to the left of the printing head 30. The processing head 40 moves integrally with the printing head 30 and the scan head 70. The processing head 40 includes a main body 42, a spindle 44, a processing tool 45 detachably attached to the spindle 44, and a fifth motor 46 to rotate the spindle 44. The spindle 44 rotates the processing tool 45. The main body 42 is movable along the fourth guide rails 64. The main body 42 moves in the up-down direction upon receipt of a driving force of a sixth motor 40A (see FIG. 2). This moves the processing head 40 in the up-down direction. The sixth motor 40A is controlled by the controller 80. The spindle 44 is attached to the main body 42. The fifth motor 46 is attached to the main body 42. The fifth motor 46 is located above the spindle 44. The fifth motor 46 is controlled by the controller 80.

The printing table 50 holds the thermoplastic resin 38 discharged from the nozzle 34 of the printing head 30. The three-dimensional object 15 is printed on the printing table 50. The printed three-dimensional object 15 is kept on the printing table 50 until the measurement by the scan head 70 and the processing by the processing head 40 are finished. The printing table 50 is located in the housing 22. The printing table 50 is located below the printing head 30, the processing head 40 and the scan head 70. The printing table 50 is provided above the bottom wall 22C. The printing table 50 is movable along a guide rail (not shown) provided on the bottom wall 22C. The printing table 50 moves in a front-rear direction upon receipt of a driving force of a seventh motor 50A (see FIG. 2). The seventh motor 50A is controlled by the controller 80.

The controller 80 controls the printing of the three-dimensional object 15, the measurement of the surface shape of the three-dimensional object 15, and the processing on the surface of the three-dimensional object 15. In more detail, the controller controls the printing head 30, the processing head 40, the printing table 50, the carriage 60, the scan head 70 and the like. The controller 80 controls the printing head 30, the processing head 40 and the scan head 70 based on the three-dimensional data of the three-dimensional object 15 to be printed. There is no specific limitation on the structure of the controller 80. For example, the controller 80 may be a computer and may include a central processing unit (hereinafter, referred to as a “CPU”), a ROM having, for example, a program or programs executable by the CPU stored thereon, a RAM and the like. The “three-dimensional data” refers to point cloud data, namely, three-dimensional coordinate data representing XYZ coordinate values, STL data including a normal vector to the plane of each of triangles that form a three-dimensional model and coordinate values of three apexes of each of the triangles, or the like.

As shown in FIG. 2, the controller 80 is configured or programmed to include a storage 82, a slice image creator 84, a printing path data creator 86, a printing head controller 88, a scan path data creator 90, a scan head controller 92, a specifier 94, a processing path data creator 96, and a processing head controller 98.

The storage 82 stores three-dimensional data of a three-dimensional object to be printed. FIG. 4 shows an example of three-dimensional object theoretically printed based on the three-dimensional data stored in the storage 82 (hereinafter, such a three-dimensional object will be referred to as a “target three-dimensional object 20”). The storage 82 stores position information on the target three-dimensional object 20. Herein, the “position information on the target three-dimensional object 20” includes, for example, both of origin information O on the target three-dimensional object 20 and contour information representing a surface shape of the target three-dimensional object 20 based on the origin information O. The position information on the target three-dimensional object 20 is three-dimensional coordinate data based on the surface shape of the target three-dimensional object 20. The storage 82 stores a plurality of slice images provided by the target three-dimensional object 20 being sliced at predetermined intervals. In this preferred embodiment, the slice images are created by the slice image creator 84. The three-dimensional data is read into the storage 82 from a storage medium or another computer (not shown) by an operation of a user. The slice images may be, for example, read into the storage 82 from a storage medium or another computer (not shown) by an operation of the user.

The slice image creator 84 slices the target three-dimensional object 20 stored in the storage 82 at predetermined intervals in the up-down direction (Z axis direction) to create the plurality of slice images corresponding to cross-sectional shapes of the target three-dimensional object 20. The target three-dimensional object 20 is sliced in a direction parallel or substantially parallel to an XY plane. The predetermined intervals are, for example, longer than, or equal to, the nozzle diameter D.

The printing path data creator 86 creates, based on the created plurality of slice images, printing path data representing a movement path of the printing head 30. The created printing path data is stored in the storage 82. The movement path of the printing head 30 is a trace drawn by the bottom end 34B of the nozzle 34.

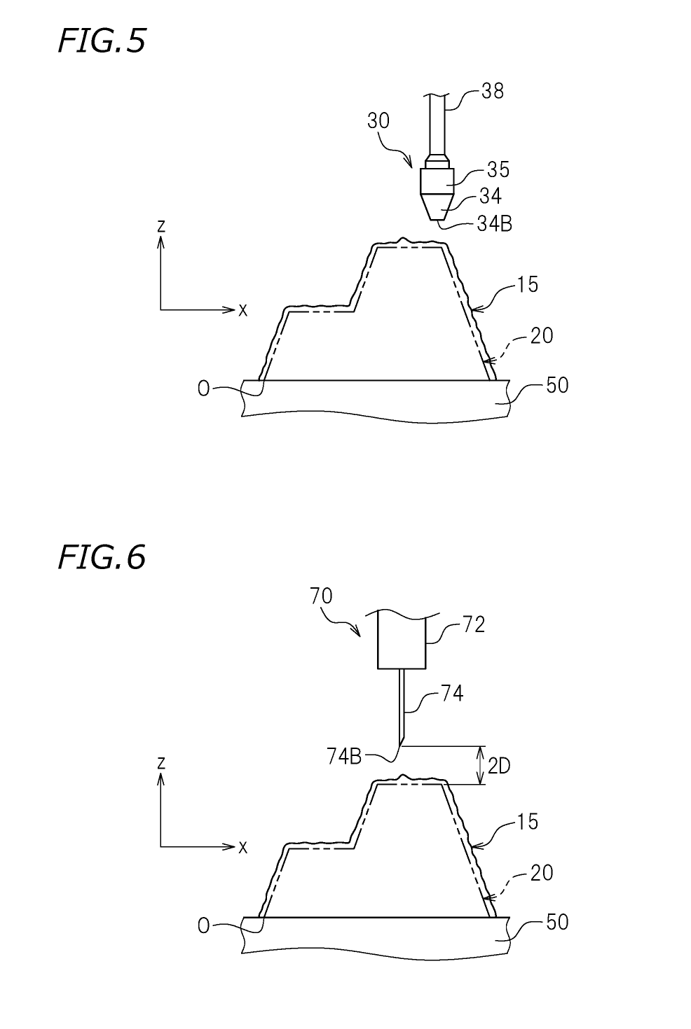

The printing head controller 88 controls the printing head 30 such that the printing head 30 discharges the thermoplastic resin 38 toward the printing table 50 based on the three-dimensional data stored in the storage 82. Namely, the printing head controller 88 uses the printing path data to control the discharge of the thermoplastic resin 38 by the printing head 30 and the movement of the printing head 30. The printing head controller 88 drives the first motor 60A to control the movement of the carriage 60. The printing head controller 88 drives the second motor 30A to control the movement of the printing head 30. The printing head controller 88 drives the third motor 36A to control the roller gears 36. The printing head controller 88 drives the seventh motor 50A to control the movement of the printing table 50. As a result, as shown in FIG. 5, the three-dimensional object 15 is printed on the printing table 50. In FIG. 5, the target three-dimensional object 20 is represented by the two-dot chain line.

The scan path data creator 90 creates, based on the three-dimensional data stored in the storage 82, scan path data representing a movement path of the scan head 70 with respect to the three-dimensional object 15 printed on the printing table 50. Referring to FIG. 6, where the nozzle diameter of the nozzle 34 is D (see FIG. 3), the movement path of the scan head 70 is distanced from the surface of the target three-dimensional object 20 by, for example, about D to about 3D in the vertical direction. In this preferred embodiment, the movement path of the scan head 70 is distanced from the surface of the target three-dimensional object 20 by 2D in the vertical direction. The created scan path data is stored in the storage 82. The movement path of the scan head 70 is a trace drawn by the bottom end 74B of the contact sensor 74. The contact sensor 74, when reaching each of predetermined measurement points on the movement path, moves downward from the main body 72 to contact the three-dimensional object 15. The measurement points may be arbitrarily set by the user.

The scan head controller 92 controls the scan head 70 such that the scan head 70 measures the surface shape of the three-dimensional object 15 located on the printing table 50 based on the three-dimensional data stored in the storage 82. Namely, the scan head controller 92 uses the scan path data to control the movement of the scan head 70 and controls the contact sensor 74. The scan head controller 92 drives the first motor 60A to control the movement of the carriage 60. The scan head controller 92 drives the fourth motor 70A to control the movement of the scan head 70. The scan head controller 92 drives the seventh motor 50A to control the movement of the printing table 50. The scan head controller 92 uses an actuator (not shown) to control the contact sensor 74. As a result, the surface shape of the three-dimensional object 15 (namely, three-dimensional coordinates of the three-dimensional object 15) is measured. The scan head controller 92 may control the scan head 70 such that the scan head 70 measures the surface shapes at the predetermined points of the three-dimensional object 15 located on the printing table 50 (namely, such that the scan head 70 performs sample scan) based on the three-dimensional data stored in the storage 82. In this case, the scan head controller 92 estimates the entire surface shape of the three-dimensional object 15 based on the measured surface shapes at the predetermined points.

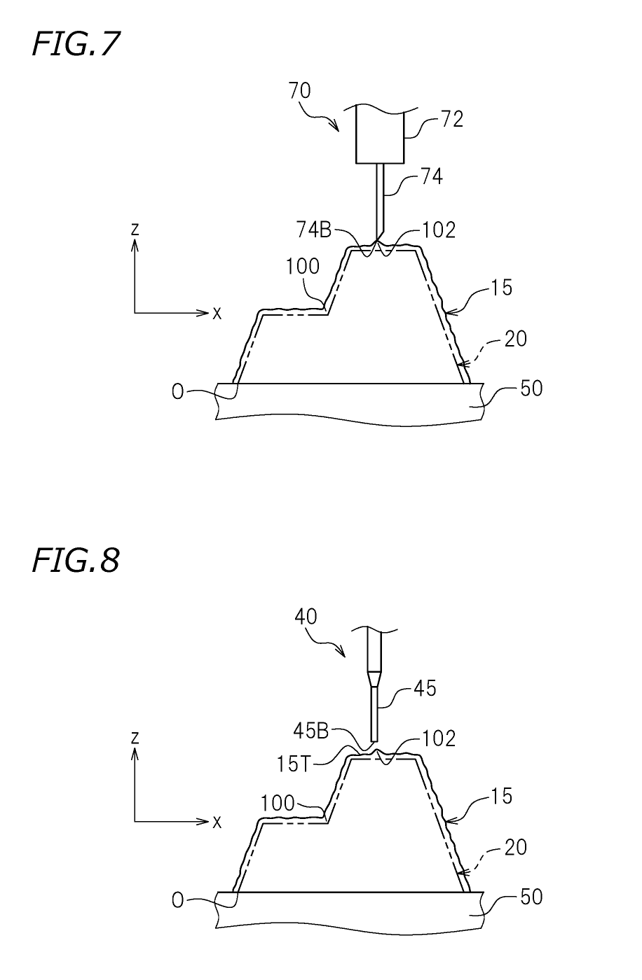

Referring to FIG. 7, the specifier 94 (see FIG. 2) specifies an extra portion 100, which is a difference between the surface shape of the three-dimensional object 15 measured by the scan head 70 and the surface shape of the target three-dimensional object 20. In FIG. 7, the extra portion 100 is enclosed by a contour line of the three-dimensional object 15 and a contour line of the target three-dimensional object 20. In general, in the case where the thermoplastic resin 38 (see FIG. 3) is used to print the three-dimensional object 15, the three-dimensional object 15 is printed to be slightly larger than the target three-dimensional object 20. The specifier 94 specifies the extra portion 100 from the three-dimensional object 15 actually printed and the target three-dimensional object 20. The specifier 94 specifies a thickest portion 102, which is thickest of the extra portion 100. The thickest portion 102 is a portion that is thickest of the extra portion 100 in the vertical direction with respect to the surface of the target three-dimensional object 20. In the case where the three-dimensional object 15 includes a plurality of planes, the thickest portion 102 may be specified for each of the planes. Position information on the extra portion 100 and the thickest portion 102 is stored in the storage 82.

The processing path data creator 96 creates, based on the position information on the extra portion 100, processing path data representing a movement path of the processing head 40 with respect to the three-dimensional object 15 printed on the printing table 50. The processing path data creator 96 creates the processing path data such that, for example, the thickest portion 102 is first processed. The created processing path data is stored in the storage 82. The movement path of the processing head 40 is a trace drawn by a bottom end 45B (see FIG. 8) of the processing tool 45.

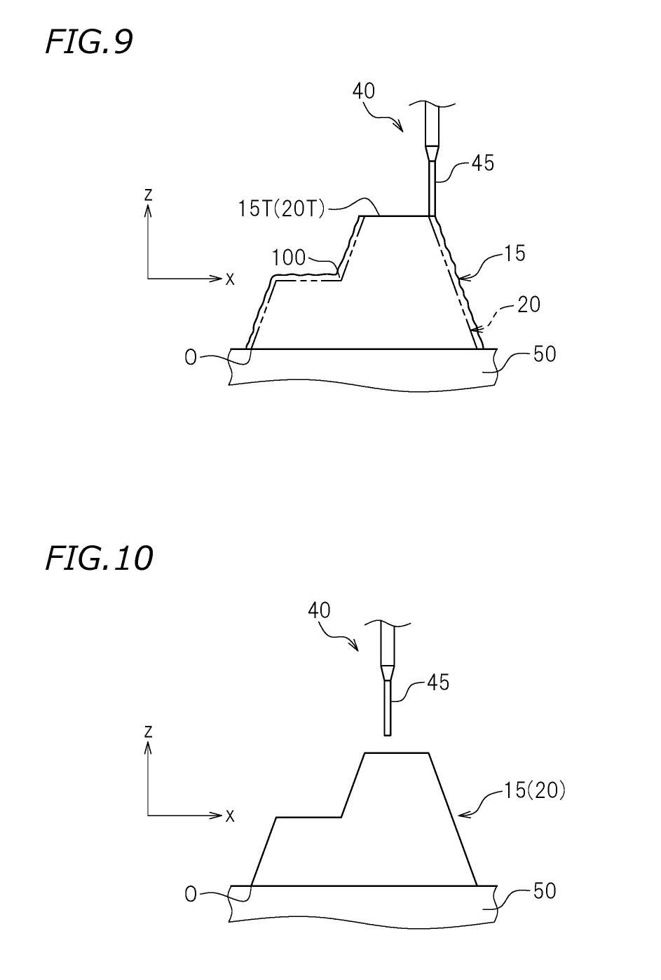

The processing head controller 98 controls the processing head 40 such that the processing head 40 cuts the extra portion 100. Namely, the processing head controller 98 uses the processing path data to control the processing on the extra portion 100 by the processing head 40 and the movement of the processing head 40. The processing head controller 98 drives the first motor 60A to control the movement of the carriage 60. The processing head controller 98 drives the fifth motor 46A to control the rotation of the spindle 44. The processing head controller 98 drives the sixth motor 40A to control the movement of the processing head 40. The processing head controller 98 drives the seventh motor 50A to control the movement of the printing table 50. As a result, the surface of the three-dimensional object 15 is processed. The processing head controller 98 further controls the processing head 40 such that, as shown in FIG. 8, the processing head 40 first cuts the thickest portion 102. As a result, the thickest portion 102 at the surface of the three-dimensional object 15 is first cut. FIG. 9 shows a state where the extra portion 100 including the thickest portion 102 (see FIG. 8) at a top surface 15T of the three-dimensional object 15 is cut. As shown in FIG. 9, the top surface 15T of the three-dimensional object 15 generally matches a top surface 20T of the target three-dimensional object 20. FIG. 10 shows a state where the extra portion 100 (see FIG. 8) of the three-dimensional object 15 is cut away. As shown in FIG. 10, the shape of the three-dimensional object 15 after the extra portion 100 is cut away generally matches the shape of the target three-dimensional object 20.

As described above, in this preferred embodiment, at the time of measuring and processing the three-dimensional object 15, printed on the printing table 50, by the scan head 70 and the processing head 40, the position of the origin does not need to be adjusted, for the following reasons. The relative positions of the scan head 70 and the processing head 40 are specified by the three-dimensional processing device 10, and the scan head 70 and the processing head 40 use the same three-dimensional data of the three-dimensional object. The scan head controller 92 controls the scan head 70 such that the scan head 70 measures the surface shape of the three-dimensional object 15 based on the three-dimensional data. Now, based on the three-dimensional data, the portion of the printing table 50 in which the three-dimensional object 15 is located is determined. Therefore, the surface shape of the three-dimensional object 15 may be measured after the scan head 70 is moved to the vicinity of the three-dimensional object 15. Specifically in the case where the scan head 70 includes the contact sensor 74 contacting a target to measure the shape thereof, the total time in which the scan head 70 moves is significantly shortened. The processing head controller 98 controls the processing head 40 such that the processing head 40 cuts the extra portion 100 specified by the specifier 94. The specifier 94 clarifies which portion of the three-dimensional object 15 needs to be cut and how much the portion needs to be cut. Therefore, the processing head 40 may be moved immediately to the extra portion 100 for processing. This significantly shortens the total time in which the processing head 40 moves. In general, the time required to discharge the thermoplastic resin 38 to print the three-dimensional object 15 is longer than the time required to process the surface of the three-dimensional object 15 by the processing head 40. The time required for the printing may be shortened by, for example, increasing the diameter of the thermoplastic resin 38 discharged from the printing head 30 and thus increasing the amount of the thermoplastic resin 38 discharged per unit time. However, in this case, the precision of the shape of the three-dimensional object 15 is decreased. By contrast, according to a preferred embodiment of the present invention, even if the amount of the thermoplastic resin 38 discharged per unit time from the printing head 30 is increased and thus the three-dimensional object 15 has a rough surface shape, the printed three-dimensional object 15 finally provided is of a high quality because the surface of the three-dimensional object 15 is processed after the printing. Namely, the time required to print the three-dimensional object 15 is shortened.

In this preferred embodiment, the scan head controller 92 controls the scan head 70 such that the scan head 70 measures the surface shapes at predetermined points of the three-dimensional object 15 located on the printing table 50 based on the three-dimensional data stored in the storage 82. The scan head controller 92 further estimates the entire surface shape of the three-dimensional object 15 based on the measured surface shapes at the predetermined points. As long as the three-dimensional processing device 10 predicts the surface of the three-dimensional object 15 at which the convex and concave portions will be caused immediately after the three-dimensional object 15 is printed with the thermoplastic material 38 (i.e., immediately before the three-dimensional object 15 is processed by the processing head 40) or predicts the value of thickness to be cut by the processing head 40 in a later step (the values of the thicknesses of the surface portion to be cut; and the maximum value of the thicknesses of the surface portion to be cut, the surface portion to be cut including the convex and concave portions), the scan head 70 does not need to scan the entirety of the three-dimensional object 15 (i.e., full scan). The scan head 70 may scan the three-dimensional object 15 at predetermined several points (sample scan) and estimate the entire surface shape of the three-dimensional object 15 based on the results of the sample scan. This significantly decreases the total time in which the scan head 70 moves.

In this preferred embodiment, as shown in FIG. 8, the processing head controller 98 controls the processing head 40 such that the processing head 40 first cuts the thickest portion 102. This further decreases the amount of motion of the processing head 40 of becoming closer to, or farther from, the three-dimensional object 15. As a result, the total time in which the processing head 40 moves is shortened.

In this preferred embodiment, as shown in FIG. 2, the processing head controller 98 uses the processing path data created by the processing path data creator 96 to control the processing on the extra portion 100 by the processing head 40 and the movement of the processing head 40. As a result, the extra portion 100 of the created three-dimensional object 15 is cut more certainly.

In this preferred embodiment, as shown in FIG. 6, the movement path of the scan head 70 is distanced from the surface of the target three-dimensional object 20 merely by 2D in the vertical direction. Since the scan head 70 may be thus close to the three-dimensional object 15, the surface shape of the three-dimensional object 15 is measured more quickly.

In this preferred embodiment, as shown in FIG. 1, the printing head 30 includes the heater 35 to heat the thermoplastic resin 38. The thermoplastic resin 38 is softened by the heater 35 and then cured on the printing table 50, so that the three-dimensional object 15 is printed. The three-dimensional object 15 created in this manner may have convex and concave portions at a surface thereof. However, in this preferred embodiment, a certain portion of the three-dimensional object 15 is cut at the surface thereof. Therefore, the three-dimensional object 15 finally provided is smooth with no convex or concave portion and thus is of a high quality.

In the above-described preferred embodiment, the scan head 70 includes the contact sensor 74, which is of a contact type. The scan head 70 is not limited to having such a structure. The scan head 70 may include a sensor that measures the surface shape of the three-dimensional object 15 in a non-contact manner by use of laser light.

In the above-described preferred embodiment, the printing head 30, the processing head 40 and the scan head 70 are provided on one carriage 60. The three-dimensional processing device 10 is not limited to this. The printing head 30, the processing head 40 and the scan head 70 may be structured to move independently from each other. There is no specific limitation on the positional relationship among the printing head 30, the processing head 40 and the scan head 70. The printing head 30, the processing head 40 and the scan head 70 may be replaced in the positions.

While preferred embodiments of the present invention have been described above, it is to be understood that variations and modifications will be apparent to those skilled in the art without departing from the scope and spirit of the present invention. The scope of the present invention, therefore, is to be determined solely by the following claims

1-6. (canceled)

7. A three-dimensional processing device that prints a three-dimensional object by sequentially stacking layers of a resin material respectively having cross-sectional shapes in accordance with slice images representing cross-sectional shapes of the three-dimensional object to be printed, the three-dimensional processing device comprising:
a printing head that discharges the resin material based on three-dimensional data of the three-dimensional object to be printed;
a printing table that holds the resin material discharged from the printing head;
a scan head that measures a surface shape of the three-dimensional object located on the printing table and printed with the resin material;
a processing head that processes a surface, having the measured shape, of the three-dimensional object located on the printing table; and
a controller that controls the printing head, the scan head and the processing head; wherein
the controller includes:
a printing head controller that controls the printing head such that the printing head discharges the resin material toward the printing table based on the three-dimensional data;
a scan head controller that controls the scan head such that the scan head measures the surface shape of the three-dimensional object located on the printing table based on the three-dimensional data;
a specifier that specifies an extra portion, which is a difference between the surface shape of the three-dimensional object measured by the scan head and a surface shape of a three-dimensional object theoretically printed based on the three-dimensional data; and
a processing head controller that controls the processing head such that the processing head cuts the extra portion.

8. The three-dimensional processing device according to claim 7, wherein the scan head controller controls the scan head such that the scan head measures surface shapes at predetermined points of the three-dimensional object located on the printing table based on the three-dimensional data, and estimates an entire surface shape of the three-dimensional object based on the measured surface shapes at the predetermined points.

9. The three-dimensional processing device according to claim 7, wherein
the specifier specifies a thickest portion of the extra portion; and
the processing head controller controls the processing head such that the processing head first cuts the thickest portion.

10. The three-dimensional processing device according to claim 7, wherein
the controller further includes a processing path data creator that creates, based on position information on the extra portion, processing path data representing a movement path of the processing head with respect to the created three-dimensional object; and
the processing head controller uses the processing path data to control the processing on the extra portion by the processing head and the movement of the processing head.

11. The three-dimensional processing device according to claim 7, wherein
the controller further includes a scan path data creator that creates, based on the three-dimensional data, scan path data representing a movement path of the scan head with respect to the created three-dimensional object;
the printing head includes a nozzle that discharges a resin material; and
where the nozzle has a nozzle diameter D, the movement path of the scan head is distanced from a surface of the three-dimensional object theoretically printed based on the three-dimensional data by D to 3D in a vertical direction.

12. The three-dimensional processing device according to claim 7, wherein
the resin material is a thermoplastic resin; and
the printing head includes a heater that heats the thermoplastic resin.
